(19) United States
(12) Patent Application Publication
(10) Pub. No.: US 2025/0114261 A1
(43) Pub. Date: Apr. 10, 2025

(54) APPARATUS FOR HOLDING AND MOVING A HAMMOCK IN AN INCUBATOR

(71) Applicant: Loewenstein Medical Technology S.A., Luxembourg (LU)

(72) Inventors: Volker SCHUMANN, Berlin (DE); Martin STAHL, Damscheid (DE)

(21) Appl. No.: 18/904,235

(22) Filed: Oct. 2, 2024

(30) Foreign Application Priority Data
Oct. 6, 2023 (DE) 102023127317.5

(51) Int. Cl. A61G 11/00

(52) U.S. Cl. CPC A61G 11/00

(57) ABSTRACT

An apparatus for holding and moving a hammock in an incubator for a preterm or neonate comprises fastening elements configured to fasten the hammock on a fastening portion of the incubator so that a lying surface of the hammock extends in an incubator chamber of the incubator; a movement arm having a receiver for receiving a portion of the hammock; a mechanism configured to couple the movement arm with a coupling portion of the incubator, so that the movement arm can be moved to and fro relative to the coupling portion.

### CROSS-REFERENCE TO RELATED APPLICATIONS

The present application claims priority under 35 U.S.C. § 119 of German Patent Application No. 102023127317.5, filed Oct. 6, 2023, the entire disclosure of which is expressly incorporated by reference herein.

### BACKGROUND OF THE INVENTION

### 1. Field of the Invention

The invention relates to an apparatus for holding and moving a hammock in an incubator for a preterm or neonate. The invention furthermore relates to a hammock which is suitable for use with such an apparatus, and to an incubator for a preterm or neonate.

### 2. Discussion of Background Information

An incubator for a preterm or neonate may comprise an incubator chamber in which the preterm or neonate can be placed to protect it from environmental influences. Such an incubator chamber is generally heatable. Usually, the preterm or neonate is placed on a flat lying surface of the incubator. Alternatively, a hammock may also be used. Such a hammock has the advantage over a flat lying surface that it can tightly enclose the preterm or neonate in a similar way as in the womb. This can have a positive influence on the preterm or neonate. However, the fastening of the hammock in the incubator chamber may entail certain difficulties owing to the limited space.

In view of the foregoing, it would be advantageous to have available an improved apparatus for holding and moving a hammock in an incubator for a preterm or neonate. It further would be advantageous to have available an improved hammock for use with such an apparatus as well as an improved incubator for a preterm or neonate.

### SUMMARY OF THE INVENTION

In a first aspect the invention provides an apparatus for holding and moving a hammock in an incubator for a preterm or neonate. The incubator comprises an incubator chamber for receiving the preterm or neonate, a fastening portion and a coupling portion. The apparatus comprises: fastening elements which are configured to fasten the hammock on the fastening portion so that a lying surface of the hammock extends in the incubator chamber; a movement arm having a receiver for receiving a portion of the hammock; a mechanism which is configured to couple the movement arm with the coupling portion so that the movement arm can be moved to and fro relative to the coupling portion, as a result of which the hammock fastened on the fastening portion and received by the receiver is set in a rocking movement.

Such an apparatus has the advantage that the hammock can be moved to and fro in a controlled fashion by the mechanism in order to generate the rocking movement. This makes it possible to move the hammock to and fro with the aid of a corresponding drive even in a closed incubator chamber. In addition, the apparatus may be implemented with little design outlay. A further advantage is the small space requirement of the apparatus, which can simplify access to the preterm or neonate or other objects in the incubator chamber. The apparatus also allows simple operation and efficient cleaning.

A “rocking movement” may generally be understood as a swaying movement which is suitable for calming the preterm or neonate lying in the hammock. Such a rocking movement may for example be induced by lateral to-and-fro pivoting of the hammock and/or by raising and lowering a first end of the hammock relative to a second end of the hammock.

The portion of the hammock that is received by the receiver may be a head end, a foot end or a portion of the hammock that lies between the head end and the foot end.

For example, the fastening element may be configured to fasten the hammock with its head end and/or its foot end on the fastening portion. In particular, the fastening element may be configured to fasten the hammock with its head and foot ends on mutually opposite walls of the incubator chamber. In addition, the fastening element may be configured to fasten the hammock in different vertical positions in the incubator, i.e. to adjust a height of the hammock.

Such a height variation may, for example, take place with the aid of one or more (for example two) vertically variable transverse rods on which the hammock is respectively fastened. For this purpose, each transverse rod may be guided along two vertical posts. The retention of the transverse rod in a particular vertical position may take place by clamping the transverse rod firmly between the two posts. For this purpose, the transverse rod may be embodied as a telescopic rod. For example, the telescopic rod may have a (central) handle region and be configured so that it becomes longer by rotation of the handle region in a particular direction of rotation, as a result of which it is clamped firmly between the two posts.

Two-point fastening of the hammock at the head end in combination with one-point fastening at the foot end may also be envisioned (or vice versa). For example, the two-point fastening may take place with the aid of a (transverse) rod or another elongate element with similar stability and/or the one-point fastening may take place with the aid of a string.

The movement arm may for example be configured in the form of a post, a fork or a stirrup. It is also possible for the movement arm to have an opening that is configured so that a hand can be inserted through the opening. This improves the access to the interior of the incubator or the incubator chamber.

Alternatively, the movement arm may be formed at least partially by at least one rope or at least one pulley. In this case, the receiver of the movement arm may be a first end of the rope, which is fastened on a portion of the hammock. For example, a second end of the rope may be fastened on a base plate of the mechanism (see below). The rope may, for example, be suitably deflected one or more times and/or adjustable in its length. The movement arm may preferably be configured to set the hammock in a predominantly horizontal rocking movement during the to-and-fro movement relative to the coupling portion, for example by a tensile force being exerted on the hammock by means of the rope or pulley, the horizontal component of which is significantly greater than (for example at least two times or at least three times as great as) its vertical component. Alternatively, the tensile force may act exclusively in the horizontal direction.

The receiver may be regarded as a portion of the movement arm. In other words, the receiver may move to and fro together with the movement arm when the movement arm is moved to and fro relative to the coupling portion, i.e., moved in mutually opposite directions.

Alternatively, the receiver may be mounted so that it can be moved relative to the movement arm. In this case, the movement arm and the receiver can be mechanically coupled to one another so that the movement of the movement arm in a particular direction is converted into a corresponding movement of the receiver (and therefore of the portion of the hammock that is received by the receiver).

In a second aspect the invention provides a hammock suitable for use with an apparatus as described above and below. The hammock comprises: a lying surface which is configured so that it can (purposely) be altered in its shape by gathering of at least one portion of the lying surface; a gathering device which is configured to gather the at least one portion of the lying surface to a different extent and to hold it gathered in a particular position.

Such a hammock can be adapted in its shape simply and reliably to a very wide variety of requirements and situations. In addition, the hammock is simple to mount and dismount. A further advantage is that the means for adapting the shape of the hammock occupy only little space in the incubator chamber.

The hammock may be configured so that it can be fastened—for example with its head end and/or its foot end—on a fastening portion of an incubator for a preterm or neonate, for example of the incubator as described above and below, as a result of which its lying surface extends in an incubator chamber of the incubator.

A “lying surface” may generally be understood as a kind of mat or net. The lying surface may, for example, be produced from a (woven) textile material and/or a plastic. For hygienic reasons, the lying surface or the (entire) hammock may be configured so that it can be washed at a temperature of at least about 60° C., in particular at least about 90° C. and/or autoclaved. Depending on the selected longitudinal position of the holding element, the lying surface may be at least partially flat and/or at least partially arched. For example, the at least partially arched lying surface may at least partially surround a preterm or neonate laid thereon in the manner of a tube or trough.

In a third aspect the invention provides an incubator for a preterm or neonate. The incubator comprises an incubator chamber for receiving the preterm or neonate. The incubator may further comprise a fastening portion, a coupling portion and an apparatus as described above and below. In addition or alternatively, the incubator may comprise a hammock as described above and below.

The incubator chamber may be heatable and/or configured so that a particular humidity prevails in its interior, for example at least about 70 percent.

The fastening portion may differ from the coupling portion. Alternatively, the fastening portion may comprise at least a part of the coupling portion (or vice versa).

Various embodiments of the invention will be described below. These embodiments are not to be understood as a restriction of the scope of the invention.

In general, the to-and-fro movement of the movement arm relative to the coupling portion may comprise a translation and/or a rotation of the movement arm.

According to one embodiment, the to-and-fro movement of the movement arm relative to the coupling portion may comprise: a translation of the movement arm in mutually opposite translation directions or a rotation of the movement arm in mutually opposite rotation directions or a combination of a translation of the movement arm in mutually opposite translation directions with a rotation of the movement arm in mutually opposite rotation directions. In other words, the mechanism may be configured to mount the movement arm on the coupling portion displaceably in mutually opposite directions along an at least partially straight and/or at least partially curved path. Additionally or alternatively, the mechanism may be configured to mount the movement arm on the coupling portion rotatably in mutually opposite directions about an axis of rotation. The axis of rotation may, for example, be aligned parallel or transversely with respect to the longitudinal direction of the hammock. It is possible for the axis of rotation to lie on a midaxis of the hammock.

According to one embodiment, the apparatus may be configured so that—when the movement arm is moved to and fro relative to the coupling portion—the portion of the hammock that is received by the receiver is moved to and fro relative to the receiver, for example along the receiver. The portion of the hammock that is received by the receiver may in this case be displaceable and/or rotatable relative to the receiver in mutually opposite directions.

According to one embodiment, the apparatus may be configured so that—when the movement arm is moved in a first direction relative to the coupling portion—the portion of the hammock that is received by the receiver is moved in a second direction different from the first direction. This allows a particularly simple structure of the apparatus, in particular compared with an embodiment in which the hammock is mounted (on both sides) rotatably about its midaxis. The first and second directions may be rotation directions that differ from one another or translation directions that differ from one another. Alternatively, the first direction may be a translation direction and the second direction may be a rotation direction (or vice versa).

According to one embodiment, the receiver may comprise an edge for contact with the hammock. The edge may be configured so that—when the movement arm is moved in the first direction—the hammock in contact with the edge is moved along the edge in the second direction. The edge may form a sloping plane along which the hammock can glide during the to-and-fro movement of the movement arm. In other words, an “edge” may be understood as an oblique edge that runs obliquely with respect to an (imaginary) horizontal or vertical line in the operational state of the apparatus. The edge may run at least partially in straight line and/or at least partially curved as seen in its longitudinal direction. For example, the edge may be configured so that the hammock in contact with the edge does not significantly change in its position with regard to the first direction when it is moved along the edge in the second direction. In this way, an additional acceleration of the hammock, which under certain circumstances is undesired, in the first direction and/or in a direction opposite to the first direction may be avoided during the rocking movement.

According to one embodiment, the receiver may comprise a slot for suspension of the hammock. The edge may in this case be formed by at least a part of an outer contour of the slot. In other words, the edge may at least partially delimit the slot. The slot may be closed or open.

According to one embodiment, the first direction may run transversely or obliquely with respect to the second direction. In other words, the first and second directions may be mutually orthogonal directions. The first and second directions may however also make an angle not equal to 90 degrees, i.e. they may extend obliquely with respect to one another. Alternatively, the first and second directions may be mutually opposite directions.

According to one embodiment, the first direction may be a vertical or horizontal direction.

According to one embodiment, the apparatus may be configured so that—when the movement arm is moved back in a third direction opposite to the first direction—the portion of the hammock that is received by the receiver is moved back in a fourth direction opposite to the second direction.

According to one embodiment, the mechanism may comprise a base plate and a pivot device. The movement arm may in this case be fastened with one of its ends on the base plate and have the receiver at its free end. The base plate may be capable of being applied on the coupling portion so that it can that pivot in mutually opposite directions via the pivot device. A “pivot device” may for example be understood as an articulation, a lifting column or a combination of at least two of these examples. For example, the base plate may form a seesaw with the aid of the pivot device. A “seesaw” may generally be understood as an element which can be rotated to and fro about an axis of rotation respectively by a particular angle less than 90 degrees, preferentially by an angle of from 0 to 45 degrees, particularly preferentially by an angle of from 0 to 20 degrees. The movement arm may be firmly connected to the seesaw. In other words, the movement arm may be fastened on the seesaw so that it is moved to and fro together with the seesaw during the to-and-fro movement of the seesaw.

According to one embodiment, the apparatus may further comprise an additional lying surface (different than the lying surface of the hammock) for the preterm or neonate. The additional lying surface may be formed by a portion of the base plate and/or a portion of a mattress arranged on the base plate. In other words, the base plate or at least a part thereof may be configured as a flat lying surface for the preterm or neonate. The preterm or neonate may therefore be placed on the lying surface of the hammock or the additional lying surface as required. For example, the hammock needs only to be pushed to one side or removed when the preterm or neonate is intended to be placed on the additional lying surface.

According to one embodiment, the mechanism may comprise an electrical drive for controlled to-and-fro movement of the movement arm relative to the coupling portion. The electrical drive may comprise an electric motor and—additionally—a gearbox for converting a rotation of a drive shaft of the electric motor into a rotation and/or translation of the movement arm relative to the coupling portion. This makes operation of the apparatus more convenient. The electrical drive may additionally comprise a time switch, which is configured to set the hammock in rocking movements for a predetermined time. Further, the electrical drive may be configured so that a maximum excursion of the rocking movement can be predefined. This allows partially or fully automatic operation of the apparatus. The electrical drive may, for example, be configured to drive one or more lifting columns. A pneumatic drive for controlled to-and-fro movement of the movement arm relative to the coupling portion is also possible.

According to one embodiment, the fastening element may comprise the movement arm. In other words, the movement arm may be configured to fasten the hammock, for example its head or foot end, indirectly or directly on the fastening portion. For example, the movement arm may be fastened with one of its ends on the fastening portion and have the receiver at its free end.

According to one embodiment, the fastening element may comprise at least one of the following fastening elements: a rope receiver for nonslip clamping of at least one rope-like element fastened on the hammock; a hook receiver for suspension of at least one hook-like element fastened on the hammock; a loop receiver for suspension of at least one loop-like element fastened on the hammock; a knot; a bead. A “rope-like element” may be understood as an elongate element for transmitting tensile forces, for example in the form of a rope, a string, cord, a thread, a band, a wire, a chain or a combination of at least two of these examples. A “rope receiver” may for example be understood as a correspondingly formed groove or a clamp (closable by a spring force). For example, the groove may have on its inner wall, in particular on its mutually opposite inner walls, a plurality of rib-like elevations and depressions for increasing the friction between the groove and the clamped rope. A “hook-like element” may for example be understood as a hook or a cuboid or spherical element which is suitable for hooking into a corresponding hook receiver. A “hook receiver” may for example be understood as a loop-like or lug-like receiver. A “loop-like element” may for example be understood as a loop or a lug. A “loop receiver” may for example be understood as a hook-like or pin-like receiver.

For example, the rope receiver may have two inner walls which are aligned with each other in a V-shape so that they form a funnel-like depression for clamping the rope-like element. Such a funnel-like depression has the advantage that rope-like elements with different diameters can be clamped in the rope receiver without corresponding adaptation of the rope receiver being necessary. Each inner wall may in this case have fluting that consists of a plurality of mutually parallel grooves for contact with the rope-like element. Accordingly, the rope-like element may be capable of being clamped between the two flutings. The grooves of the two flutings may respectively be arranged obliquely with respect to the longitudinal direction of the clamped rope-like element, particularly in such a way that the clamped rope-like element is moved commensurately more deeply into the funnel-like depression because of the grooves when the clamped rope-like element is pulled more strongly in a particular pulling direction parallel to its longitudinal direction. In other words, each groove may form a downward sloping plane, as seen in the pulling direction, along which the rope-like element is guided toward the bottom of the funnel-like depression during the pulling in the pulling direction. Because of this self-reinforcing effect, particularly secure fastening of the rope-like element may be ensured.

The rope receiver may for example be fastened on a head or foot wall of the incubator chamber, for example screwed thereto. Alternatively, the rope receiver may be capable of being connected to a counterpart of a plug connection, which is fastened on the head or foot wall, for example by sliding the rope receiver onto the counterpart in the vertical and/or horizontal direction.

The plug connection may additionally be capable of being locked by means of a locking element. The locking element may be mounted on the incubator, for example on the head or foot wall and/or the rope receiver and/or the counterpart, so that it can be moved between a lock setting and an unlock setting. The locking element may in this case be configured to lock the plug connection in the lock setting so that release of the plug connection is not possible, and to unlock it in the unlock setting unlock so that release of the plug connection is possible.

For example, the locking element may be embodied as part of a flap for closing an access opening in the head or foot wall. It is possible for the flap to be mounted on the head or foot wall so that it can be moved between a between a closure setting and an open setting. The flap may in this case be configured to close the access opening (hermetically) in the closure setting and release it in the open setting, so that for example a hand can be passed through the access opening into the interior of the incubator chamber. It is possible for the closure setting to correspond to the lock setting and/or for the open setting to correspond to the unlock setting. In other words, the flap may be configured so that the plug connection can be locked by moving the flap into the closure setting and/or can be unlocked by moving the flap into the open setting.

The locking element may for example comprise a projection protruding from the flap (for example in the form of a bolt), which can be movable together with the flap. The projection may be capable of being moved into the lock setting by moving the flap into the closure setting, the projection being capable of engaging with a form-fit into the rope receiver that is slid onto the counterpart, for example into a depression or a hole in the rope receiver, so that the plug connection is locked. Conversely, the projection may be capable of being moved into the unlock setting by moving the flap into the open setting, the projection being capable of releasing the rope receiver so that the plug connection is unlocked.

A variant may also be envisioned in which the connection is configured so that the locking element is moved into the lock setting and/or held in the lock position because of a tensile force exerted on the rope receiver by the hammock.

The description above may also apply correspondingly to the loop receiver and/or the hook receiver.

It is also possible for the fastening means to comprise a transverse rod on the head and/or foot end of the hammock and/or one or more fastening receivers for the fastening of a transverse rod on the fastening portion. Each transverse rod may for example be slid into a corresponding tunnel or into one or more loops of the hammock. The longitudinal direction of the transverse rod may in this case run transversely with respect to the longitudinal direction of the hammock. The fastening receiver may for example have various fastening locations for the fastening, in particular suspension of the transverse rod, or more precisely of an exposed portion of the transverse rod. The various fastening locations may differ from one another in their vertical and/or horizontal position. For example, the fastening locations may be formed by grooves and/or hooks. This allows, inter alia, simple adaptation of the height and/or length of the hammock. Instead of the transverse rod, a string another suitable elongate element may also be used.

The transverse rod may for example be configured to prevent accidental slipping of a portion of the hammock that is in contact with the transverse rod, for example of the tunnel or the loop(s) of the hammock, relative to the transverse rod in its longitudinal direction when it is in the inserted state.

For this purpose, the transverse rod may for example have one or more thickened locations at which the transverse rod is enlarged significantly in its width direction (i.e. in a direction orthogonal to its longitudinal direction) in comparison with the rest of the transverse rod. Such a thickened location may for example be produced by a suitable (for example V-shaped) kink or bend of the transverse rod.

For example, such a thickened location may be positioned centrally between the two ends (delimiting the length of the transverse rod) of the transverse rod, in which case a corresponding recess for receiving the thickened location may be formed in the material of the hammock (for example as a hole in the tunnel or in the loop). The recess may be arranged centrally as seen in the direction of a width of the hammock (i.e. as seen transversely with respect to its longitudinal direction), so that the hammock—when the thickened location is received by the recess (for example is passed through the hole)—can be centered in relation to the transverse rod and held in this centered position, specifically even when the hammock is moved to and fro together with the preterm or neonate contained therein by means of the mechanism.

Additionally or alternatively, such a thickened location may be positioned off-center, for example at each of the two ends of the transverse rod, in order to prevent accidental slipping of a marginal portion of the hammock that is in contact with the transverse rod toward the middle of the transverse rod.

Further, it is possible for the apparatus to comprise a sensor for recording a position of the transverse rod relative to the fastening portion and an evaluation unit for evaluating a sensor signal generated by the sensor. The sensor may preferably be configured as a reed switch which is opened or closed when the transverse rod is fastened correctly. A simple mechanical switch or an optical sensor is, however, also possible. The evaluation unit may be configured to determine whether or not the transverse rod is fastened correctly in the incubator by evaluating the sensor signal, and as a function of the result of this evaluation to generate a control signal for controlling at least one functionality of the incubator, for example for controlling a fan and/or a display.

According to one embodiment, the apparatus, in particular the mechanism, may be configured to retain the movement arm in a particular position relative to the coupling portion.

According to one embodiment, the apparatus may further comprise at least one further movement arm having a further receiver for receiving a further portion of the hammock. In this case, the mechanism may be configured to couple the further movement arm with a further coupling portion of the incubator so that the further movement arm can be moved to and fro relative to the further coupling portion, and the apparatus may be configured so that the hammock fastened on the fastening portion and received by the receiver and the further receiver can be set in a rocking movement by to-and-fro movement of the movement arm and of the further movement arm. In other words, the hammock may be set in a suitable rocking movement with the aid of a plurality of movement arms applied at various locations of the hammock. In this way, the rocking movement can be controlled better in comparison with an embodiment having only one movement arm. The portion of the hammock that is received by the receiver and the further portion of the hammock that is received by the further receiver may be the same portion of the hammock or different portions of the hammock. The coupling portion and the further coupling portion may be the same portion of the incubator or different portions of the incubator. The apparatus may also comprise a plurality of, for example three or four, such further movement arms. It is possible for the fastening means to further comprise the further movement arm or the further movement arms. For example, the hammock may be fastened on the base plate via four (corner) posts as movement arms.

According to one embodiment, the lying surface may have a tunnel and be configured so that it can be altered in its shape by gathering of the tunnel. The gathering device may comprise: an elongate tensioning element which extends through the tunnel so that the tunnel can be gathered along the tensioning element; a holding element which can be fastened on an end of the tensioning element that protrudes from the tunnel in order to hold the tunnel gathered in a particular position.

Alternatively or additionally, the gathering device may comprise a zipper for gathering of the lying surface.

The tunnel may be connected to the lying surface so that the lying surface changes its length and/or width and/or cross-sectional shape by gathering of the tunnel. Thus, by corresponding gathering of the tunnel, it is possible to adjust for example how tightly the preterm or neonate lying in the hammock is enclosed by the lying surface. The tunnel becomes shorter by gathering of the tunnel. The shape of the lying surface is thereby also altered. For example, the lying surface thereby becomes more arched and/or shorter and/or narrower. Conversely, the lying surface becomes shallower and/or longer and/or wider when the tunnel is made longer by a corresponding position of the holding element or the holding elements, i.e. it is gathered less strongly. The length of the tunnel may, for example, be predefined by a position of the holding element or the holding elements with regard to a longitudinal direction of the tensioning element.

A “holding element” may for example be understood as a clamp or a so-called cord stopper, also known as a cord lock or Tanka, or another clamping element. Such a holding element can be fastened particularly simply and reliably in various longitudinal positions on the tensioning element. Such a holding element is in addition particularly economical. The holding element may, for example, comprise a spring for applying a suitable clamping force. The holding element may be configured so that, during intended use of the hammock, it can neither slip into the tunnel nor slip relative to the tensioning element. For example, the greatest outer diameter of the holding element may be greater than the greatest inner diameter of an opening of the tunnel.

A “tensioning element” may generally be understood as an elongate element for transmitting tensile forces, for example in the form of a bar (for example a rod), a string, a rope, a cord, a thread, a band, a wire, a chain or a combination of at least two of these examples. The tensioning element may, for example, also be configured to fasten the hammock on the fastening portion of the incubator.

The tunnel may for example be formed by a (folded) seam, a loop, a lug, a recess in the material of the lying surface or a combination of at least two of these examples. In particular, the tunnel may be embodied as a continuous or locally interrupted drawstring. The tunnel may extend as seen in its longitudinal direction in the direction of a length and/or width of the hammock. In other words, the tunnel may extend as seen in its longitudinal direction at least locally parallel, transversely or obliquely with respect to the longitudinal direction of the hammock. Additionally or alternatively, at least one longitudinal portion of the tunnel may form an outer margin of the lying surface, i.e. it may be part of an outer contour of the lying surface.

According to one embodiment, the tunnel may comprise a longitudinal portion which forms at least a part of an outer margin of the lying surface.

According to one embodiment, the tunnel may comprise a longitudinal portion which runs transversely or obliquely with respect to the longitudinal direction of the lying surface.

According to one embodiment, the tunnel may comprise a longitudinal portion which runs parallel to the longitudinal direction of the lying surface.

According to one embodiment, the tunnel may comprise a longitudinal portion which runs centrally between two mutually opposite ends of the hammock and/or connects two mutually opposite ends of the hammock to one another.

The longitudinal direction of the lying surface may in particular refer to a state of the hammock in which the lying surface is ungathered and/or relaxed and/or spread flat.

According to one embodiment, the lying surface of the hammock may have an arcuate outer margin at its head end and/or its foot end. This has the advantage over an embodiment with a straight outer margin that the preterm or neonate sinks more deeply into the hammock.

According to one embodiment, the hammock may further comprise a second holding element which can be fastened on a second end of the tensioning element that protrudes from the tunnel in order to hold the tunnel gathered between the two holding elements. In other words, the tunnel that is being held gathered may extend between the (first) holding element fastened on the tensioning element and the second holding element fastened on the tensioning element, the two holding elements delimiting the effective length of the tunnel.

According to one embodiment, the lying surface may have a further tunnel and be configured so that it can be further altered in its shape by gathering of the further tunnel. In this case, the gathering device may further comprise: a further elongate tensioning element which extends through the further tunnel so that the further tunnel can be gathered along the further tensioning element; a further holding element which can be fastened on a end of the further tensioning element that protrudes from the further tunnel in order to hold the further tunnel gathered in a particular position. The lying surface may also comprise a plurality of such further tunnels. For example, the lying surface may be configured so that it can be altered in its width by gathering of the tunnel and can be altered in its length by gathering of the further tunnel. The shape of the lying surface may therefore be adapted to different situations and requirements with few manipulations.

According to one embodiment, the incubator may comprise a frame for supporting the incubator chamber. The fastening portion may in this case comprise a portion of the frame. In other words, the fastening means of the apparatus may be configured to fasten the hammock on the frame. Additionally or alternatively, the coupling portion may comprise a portion of the frame. In other words, the mechanism of the apparatus may be configured to couple the movement arm movably with the frame. The frame may, for example, have one or more rollers for repositioning of the incubator and/or one or more lifting columns for vertical variation of the incubator chamber.

According to one embodiment, the incubator chamber may be delimited in its height by a bottom and a top and/or in its length by a head wall and a foot wall and/or in its width by a front wall and a rear wall. The fastening portion or the coupling portion, or the fastening portion and the coupling portion, may in this case comprise at least one of the following portions of the incubator chamber: the bottom, the top, the head wall, the foot wall, the front wall, the rear wall.

### BRIEF DESCRIPTION OF THE DRAWINGS

Embodiments of the invention are described below with reference to the appended drawings. Neither the description nor the drawings are to be understood as a restriction of the scope of the invention.

In the drawings:

FIG. 1 shows an incubator according to one embodiment of the invention.

FIG. 2 shows a portion of a movement arm of FIG. 1.

FIG. 3 shows a seesaw-like apparatus according to one embodiment of the invention.

FIG. 4 shows a hammock according to one embodiment of the invention.

FIG. 5 shows an outer contour of a hammock according to one embodiment of the invention.

The figures are purely schematic and not to scale. When the same reference signs are used in various drawings, these reference signs denote features that are identical or have the same effect.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

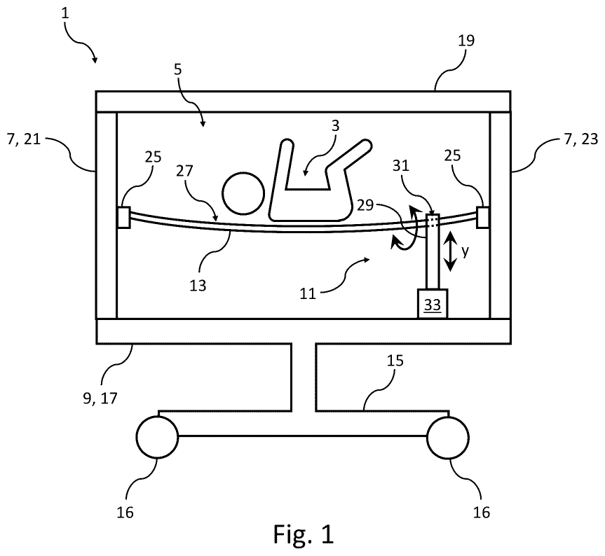

FIG. 1 shows an incubator 1 for a preterm or neonate 3. The incubator 1 comprises an incubator chamber 5 for receiving the preterm or neonate 3, a fastening portion 7, a coupling portion 9 and an apparatus 11 for holding and moving a hammock 13 in the incubator chamber 5.

The incubator 1 may additionally comprise a frame 15 for supporting the incubator chamber 5. The frame 15 may have a plurality of rollers 16 for repositioning of the incubator 1 and/or one or more lifting columns for vertical variation of the incubator chamber 5.

In this example, the incubator 5 is delimited in its height by a bottom 17 and a top 19, in its length by a head wall 21 and a foot wall 23 and/or in its width by a front wall and a rear wall (not shown).

For example, the fastening portion 7 may comprise the head wall 21 and the foot wall 23 and/or the coupling portion 9 may comprise the bottom 17. The fastening portion 7 or the coupling portion 9 may additionally or alternatively comprise other portions of the incubator 1, for example a portion of the frame 15.

The incubator chamber 5 may be heatable and/or configured to regulate the humidity in its interior.

The apparatus 11 comprises fastening means 25 which are configured to fasten the hammock 13 on the fastening portion 7, here on the head wall 21 and the foot wall 23, so that a lying surface 27 of the hammock 13 extends in the incubator chamber 5.

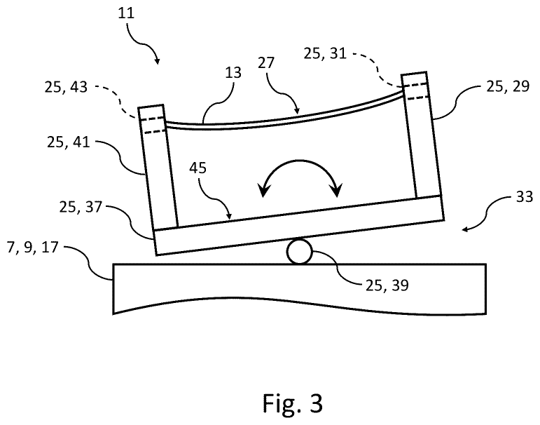

The apparatus 11 further comprises a movement arm 29 having a receiver 31 for receiving a portion of the hammock 13, and a mechanism 33 which is configured to couple the movement arm 29 with the coupling portion 9, here the bottom 17, so that the movement arm 29 can be moved to and fro relative to the coupling portion 9, as a result of which the hammock 13 fastened on the fastening portion 7 and received by the receiver 31 is set in a rocking movement (indicated by a curved double arrow). In this example, the movement arm 29 can be moved to and fro vertically (indicated by a straight double arrow). Additionally or alternatively, horizontal movement of the movement arm 29 to and fro or a rotational movement of the movement arm 29 in mutually opposite directions is possible in order to generate the rocking movement. The apparatus 11 may also comprise more than one movement arm (see FIG. 3).

The mechanism 33 may additionally comprise an electrical drive for controlled, in particular automatic, to-and-fro movement of the movement arm 29.

As shown in FIG. 1, the hammock 13 may be fastened on the fastening portion 7 by means of the fastening means 25 independently of the movement arm 29. It is, however, also possible for the movement arm 29 to function as one of the fastening means 25 (see FIG. 3).

The fastening means 25 may, for example, comprise one or more of the following receivers: a rope receiver for nonslip clamping of at least one rope-like element fastened on the hammock 13; a hook receiver for suspension of at least one hook-like element fastened on the hammock 13; a loop receiver for suspension of at least one loop-like element fastened on the hammock 13.

In addition, the fastening means 25 may be configured to fasten the hammock 13 in different vertical positions in the incubator 5, i.e. to adjust a height of the hammock 13.

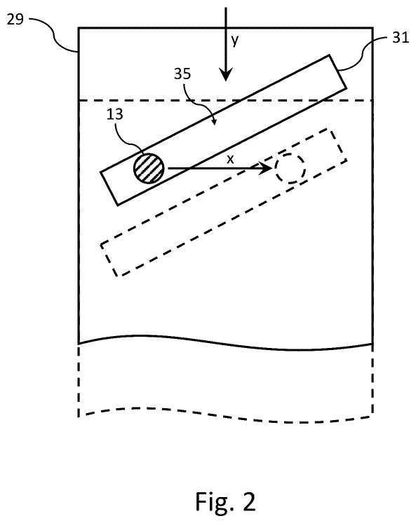

In this example, the apparatus 11 is configured so that—when the movement arm 29 is moved to and fro relative to the coupling portion 9—the portion of the hammock 13 that is received by the receiver 31 is moved to and fro relative to the receiver 31. In addition, the apparatus 11 is configured so that—when the movement arm 29 is moved in a first (here vertical) direction y relative to the coupling portion 9—the portion of the hammock 13 that is received by the receiver 31 is moved in a second (here horizontal) direction x different than the first direction y (see FIG. 2).

As shown in FIG. 2, this relative movement may for example be achieved with the aid of an oblique edge of a slot 35 for suspension of the hammock 13, for example of an end portion of the hammock 13 which is particularly narrow in comparison with the lying surface 27. FIG. 2 illustrates the way in which the hammock 13 suspended in the slot 35 is moved horizontally to and fro by vertical to-and-fro movement of the movement arm 29 in order to generate the rocking movement.

The slot 35 may, for example, be embodied as a recess in the material of the movement arm 29. Contrary to the representation in FIG. 2, the slot may be open at one of its ends in order to allow simple suspension of the hammock 13.

Here, as seen in its longitudinal direction, the slot 35 runs substantially in a straight line and obliquely with respect to the two directions x, y. Alternatively, the slot 35 may run at least partially curved, i.e. it may be more or less strongly arched.

In particular, the slot 35 may be configured so that the hammock 13 suspended in the slot 35 changes scarcely or not at all in its position with regard to the first direction y, here in its height, when it is moved along the slot 35 in the second direction x. In this way, an additional vertical acceleration of the hammock 13, which under certain circumstances is undesired, may be avoided during the rocking movement.

As shown in FIG. 3, an embodiment of the apparatus 11 is also possible in which the hammock 13 can be connected firmly to the receiver 31 so that no relative movement takes place between the hammock 13 and the receiver 31.

In this example, the mechanism 33 comprises a base plate 37, on which the movement arm 29 is fastened withone of its ends, and a pivot device in the form of an articulation 39 via which the base plate 37 may be applied on the coupling portion 9, here on the bottom 17, so that it can that pivot in mutually opposite directions, in order to form a seesaw. The movement arm 29 in this case has the receiver 31 at its free end. Alternatively or additionally, the pivot device may for example comprise one lifting columns in order to form the seesaw.

The apparatus 11 may additionally comprise a further movement arm 41, which is fastened on the base plate 37 with one of its ends at a particular distance from the movement arm 29 and has a further receiver 43 its free end for receiving a further portion of the hammock 13. The hammock 13 may in this case be fastened with its head end on the further receiver 43 and with its foot end on the receiver 31 (or vice versa) so that the lying surface 27 extends between the two movement arms 29, 41. Here, the two movement arms 29, 41 function together with the two receivers 31, 43, the base plate 37 and the articulation 39 as the fastening means 25, the fastening portion 7 being formed at least partially by the coupling portion 9, here the bottom 17. When the base plate 37 pivots, the two movement arms 29, 41 are moved with it so that the hammock 13 fastened on the two movement arms 29, 41 is set in a corresponding rocking movement.

Optionally, the base plate 37 may form an additional, flat lying surface 45 for the preterm or neonate 3. In the example shown in FIG. 3, the additional lying surface 45 is provided by a surface of the base plate 37 that faces away from the bottom 17. Alternatively, the additional lying surface 45 may be formed by a mattress arranged on the base plate 37.

The mechanism 33 may be configured to retain the base plate 37 in a particular position relative to the coupling portion 9, for example in a horizontal position or in a particular inclined position away from the horizontal position.

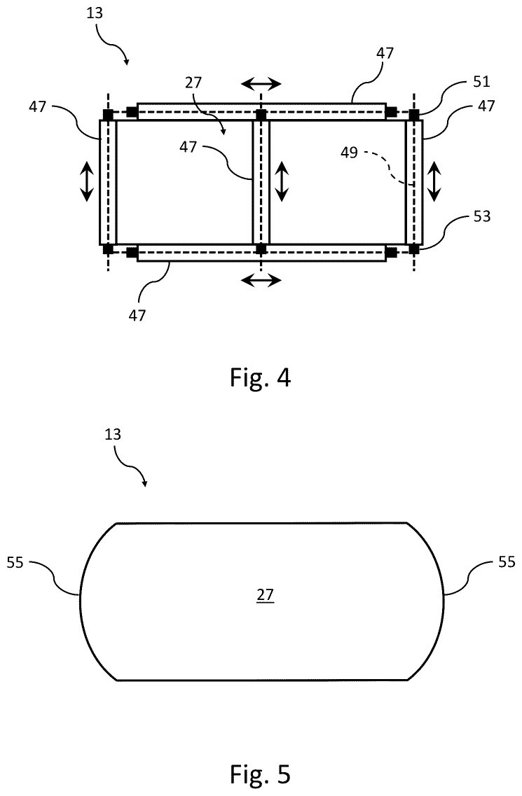

As shown in FIG. 4, the lying surface 27 of the hammock 13 may have a tunnel 47 and be configured so that it can be altered in its shape by gathering of the tunnel 47. For this purpose, the tunnel 47 may for example be firmly connected to a material of the lying surface 27, with the effect that the lying surface 27 can be altered in its length and/or width and/or cross-sectional shape by gathering of the tunnel 47, i.e. by shortening of the tunnel 47. An elongate tensioning element 49, here in the form of a string, extends through the tunnel 47 so that the tunnel 47 can be gathered along the tensioning element 49, i.e., in its longitudinal direction (indicated by double arrows). In order to hold the tunnel 47 gathered in a particular position, the hammock 13 further comprises a holding element 51 which can be clamped onto an end of the tensioning element 49 that protrudes from the tunnel 47.

The tunnel 47 may for example be formed by a (folded) seam, a loop, a lug, a recess in the material of the lying surface 27 or a combination of at least two of these examples. In particular, the tunnel 47 may be embodied as a continuous or locally interrupted drawstring.

In this example, the hammock 13 comprises a plurality of tunnels 47, each having a tensioning element 49 and one or more holding elements 51 as described above. The various tunnels 47 may, inter alia, differ from one another in their position and/or orientation in respect of the lying surface 27 and/or in their length. For example, as seen in its longitudinal direction, at least one of the tunnels 47 may run transversely or obliquely with respect to the longitudinal direction of the hammock 13 and at least one other of the tunnels 47 may, as seen in its longitudinal direction, run parallel to the longitudinal direction of the hammock 13. Additionally or alternatively, at least one of the tunnels 47 may form an outer margin of the lying surface 27 or run along an outer margin of the lying surface 27 and/or at least one of the tunnels 47 may cross the lying surface 27.

Alternatively, the tensioning element 49 may be a bar (for example a rod), a string, a rope, a cord, a thread, a band, a wire, a chain or a combination of at least two of these examples.

The holding element 51 may for example be a clamp or a so-called cord stopper, also known as a cord lock or Tanka. Such a holding element can be fastened particularly simply and reliably in various longitudinal positions on the tensioning element 49. Such a holding element is in addition particularly economical. The holding element 51 may be configured so that, during intended use of the hammock 13, it can neither slip into the tunnel 47 nor slip relative to the string 49. For example, the greatest outer diameter of the holding element 51 may be greater than the greatest inner diameter of an opening of the tunnel 47.

In this example, each tunnel 47 is held gathered between the (first) holding element 51 and a second holding element 53, which can be clamped onto a second end of the tensioning element 49 that protrudes from the respective tunnel 47. Alternatively, the tensioning element 49 may be fastened by at least one of the tunnels 47 with one of its ends in a suitable way on the hammock 13, for example knotted or stitched thereto, so that a single holding element 51 is sufficient to hold the respective tunnel 47 gathered.

As shown in FIG. 5, the lying surface 27 of the hammock 13 may respectively have an arcuate outer margin 55 at its head end and/or its foot end. This has the effect in contrast to the embodiment shown in FIG. 4 with straight outer margins that, with an otherwise unmodified structure of the hammock 13, the preterm or neonate 3 sinks more deeply into the hammock 13, which may be advantageous which under certain circumstances, for example when the preterm or neonate 3 is particularly lively.

Finally, it should be pointed out that terms such as “have”, “comprise”, “include”, “with”, etc. do not exclude other elements or steps and indefinite articles such as “a” or “an” do not exclude the plural.

Further, it should be pointed out that features or steps which are described with reference to one of the embodiments above may also be used in combination with features or steps which are described with reference to others of the embodiments above.

### LIST OF REFERENCE SIGNS

1 incubator
3 preterm or neonate
5 incubation chamber
7 fastening portion
9 coupling portion
11 apparatus
13 hammock
15 frame
16 roller
17 bottom
19 top
21 head wall
23 foot wall
25 fastening means
27 lying surface
29 movement arm
31 receiver
33 mechanism
35 slot
37 base plate
39 articulation
41 further movement arm
43 further receiver
45 additional lying surface
47 tunnel
49 tensioning element
51 (first) holding element
53 second holding element
55 arcuate outer margin
x second direction
y first direction

What is claimed is:

1. An apparatus for holding and moving a hammock in an incubator for a preterm or neonate, wherein the incubator comprises an incubator chamber for receiving the preterm or neonate, a fastening portion and a coupling portion, and wherein the apparatus comprises:
one or more fastening elements which are configured to fasten the hammock on the fastening portion so that a lying surface of the hammock extends in the incubator chamber;
a movement arm having a receiver for receiving a portion of the hammock;
a mechanism which is configured to couple the movement arm with the coupling portion so that the movement arm can be moved to and fro relative to the coupling portion, as a result of which the hammock fastened on the fastening portion and received by the receiver can be set in a rocking movement.

2. The apparatus of claim 1, wherein the to-and-fro movement of the movement arm relative to the coupling portion comprises a translation of the movement arm in mutually opposite translation directions.

3. The apparatus of claim 1, wherein the apparatus is configured so that—when the movement arm is moved to and fro relative to the coupling portion—the portion of the hammock that is received by the receiver is moved to and fro relative to the receiver; and/or wherein the apparatus is configured so that—when the movement arm is moved in a first direction (y) relative to the coupling portion—the portion of the hammock that is received by the receiver is moved in a second direction (x) different from the first direction (y).

4. The apparatus of claim 3, wherein the receiver comprises an edge for contact with the hammock, the edge being configured so that—when the movement arm is moved in the first direction (y)—the hammock in contact with the edge is moved along the edge in the second direction (x).

5. The apparatus of claim 4, wherein the receiver comprises a slot for suspension of the hammock and the edge is formed by at least a part of the outer contour of the slot.

6. The apparatus of claim 3, wherein the first direction (y) runs transversely or obliquely with respect to the second direction (x); and/or wherein the first direction (y) is a vertical or horizontal direction.

7. The apparatus of claim 1, wherein the mechanism comprises a base plate and a pivot device, the movement arm being fastened with one of its ends on the base plate and having the receiver at its free end, the base plate being capable of being applied on the coupling portion so that it can that pivot via the pivot device.

8. The apparatus of claim 7, wherein the apparatus further comprises an additional lying surface for the preterm or neonate, the additional lying surface being formed by a portion of a base plate and/or a portion of a mattress arranged on the base plate.

9. The apparatus of claim 1, wherein the mechanism comprises an electrical drive for controlled to-and-fro movement of the movement arm relative to the coupling portion.

10. The apparatus of claim 1, wherein the one or more fastening elements comprise the movement arm; and/or wherein the one or more fastening elements comprise at least one of the following fastening elements: a rope receiver for nonslip clamping of at least one rope-like element fastened on the hammock; a hook receiver for suspension of at least one hook-like element fastened on the hammock; a loop receiver for suspension of at least one loop-like element fastened on the hammock.

11. The apparatus of claim 1, wherein the apparatus further comprises a further movement arm having a further receiver for receiving a further portion of the hammock, the mechanism being configured to couple the further movement arm with a further coupling portion of the incubator so that the further movement arm can be moved to and fro relative to the further coupling portion; and the apparatus being configured so that the hammock fastened on the fastening portion and received by the receiver and the further receiver can be set in a rocking movement by to-and-fro movement of the movement arm and of the further movement arm.

12. A hammock which is suitable for use with the apparatus of claim 1, wherein the hammock comprises:
a lying surface which is configured so that it can be altered in its shape by gathering of at least one portion of the lying surface;
a gathering device which is configured to gather the at least one portion of the lying surface to a different extent and to hold it gathered in a particular position.

13. The hammock of claim 12, wherein the lying surface comprises a tunnel and is configured so that it can be altered in its shape by gathering of the tunnel; and wherein the gathering device comprises an elongate tensioning element which extends through the tunnel so that the tunnel can be gathered along the tensioning element; and a holding element which can be fastened on an end of the tensioning element that protrudes from the tunnel in order to hold the tunnel gathered in a particular position.

14. The hammock of claim 13, wherein the tunnel comprises a longitudinal portion which forms at least a part of an outer margin of the lying surface; and/or wherein the tunnel comprises a longitudinal portion which runs transversely or obliquely with respect to a longitudinal direction of the lying surface; and/or wherein the tunnel comprises a longitudinal portion which runs parallel to a longitudinal direction of the lying surface.

15. The hammock of claim 12, wherein the lying surface has an arcuate outer margin at its head end and/or its foot end.

16. An incubator for a preterm or neonate, wherein the incubator comprises an incubator chamber for receiving the preterm or neonate and further comprises a fastening portion, a coupling portion and the apparatus of claim 1.

17. An incubator for a preterm or neonate, wherein the incubator comprises an incubator chamber for receiving the preterm or neonate and further comprises the hammock of claim 12.

18. The incubator of claim 16, wherein the incubator further comprises a hammock which comprises:
a lying surface which is configured so that it can be altered in its shape by gathering of at least one portion of the lying surface;
a gathering device which is configured to gather the at least one portion of the lying surface to a different extent and to hold it gathered in a particular position.
